(19) United States
(12) Patent Application Publication
(10) Pub. No.: US 2006/0243190 A1
(43) Pub. Date: Nov. 2, 2006

(54) Sound generating arrangement

(76) Inventor: Wayne Cohen, Bangkok (TH)

Correspondence Address: DORSEY & WHITNEY LLP;INTELLECTUAL PROPERTY DEPARTMENT, 250 PARK AVENUE, NEW YORK, NY, 10177, US

(21) Appl. No.: 11/414,688

(22) Filed: Apr. 27, 2006

Related U.S. Application Data
(60) Provisional application No. 60/675,177, filed on Apr. 27, 2005.

(51) Int. Cl. G10K 9/04; G10K 5/00

(52) U.S. Cl. 116/137 R

(57) ABSTRACT

A sound generating arrangement is provided. The sound generating arrangement may be easily and quickly assembled, and can include a first arrangement, a second arrangement, and a coupling arrangement. The first arrangement may be configured to provide a flow of gas therethrough, and can comprise a mouth piece. The second arrangement may be configured to facilitate a generation of a second when it is contacted by the gas, and can have a sound generating assembly. The coupling arrangement may be elastically deformable and may be configured for coupling the first arrangement to the second arrangement.

### CROSS-REFERENCE TO RELATED APPLICATION(S)

The present application claims priority from U.S. application Ser. No. 60/675,177, filed on Apr. 27, 2005, the entire disclosure of which is incorporated herein by reference.

### FIELD OF THE INVENTION

The present invention relates generally to a sound generating arrangement, and more particularly to the sound generating arrangement including a mouthpiece arrangement, a sound making arrangement, and a coupling arrangement for coupling the mouthpiece arrangement to the sound providing arrangement.

### BACKGROUND INFORMATION

Certain situations exist in which it is desirable to make sounds/noises. These sporting events, wherein a patron may desire to generate noise to indicate their approval and/or disapproval of occurrences in play actions and/or to generally show support for their team, play situations where a child may wish to make noise, coaching situations where a coach needs to make noise to get attention, and others.

Horns or whistles can be used to generate such sounds/noises. The use of a membrane in a housing in conjunction with air to generate sound is known. High acoustic output horns producing tonal sounds are thus produced for use by sports fans or other individuals, and such sounds may be generated by blowing through a hole of the horn which interact with the membrane.

However, there remains a need for providing a lightweight, inexpensive horn that is small and has little risk of breakage.

### SUMMARY OF EXEMPLARY EMBODIMENT(S) OF THE INVENTION

In one exemplary embodiment of the present invention, a sound generating arrangement can be provided that includes a first arrangement, a second (sound making) arrangement, and a coupling arrangement for coupling the mouthpiece arrangement to the sound generating arrangement.

For example, the first arrangement may be configured to provide a flow of gas therethrough, and can comprise a mouth piece. The second arrangement may be configured to facilitate a generation of a second when it is contacted by the gas, and can have a sound generating assembly. The coupling arrangement may be elastically deformable and may be configured for coupling the first arrangement to the second arrangement.

According to another exemplary embodiment of the present invention, the second arrangement can include an elastic membrane, and the first arrangement can include an inlet tube, with the inlet tube extending toward the membrane. The second arrangement can further include a base assembly supporting the membrane. A membrane cover can be provided for placement over the membrane. The membrane cover can include at least one opening for the gas flow to be provided therethrough. For example, a plurality of openings can be provided in a customizable configuration. The membrane cover can also include a dimple on an underside thereof. By pressing on the membrane cover, the membrane dimple can contact the membrane and is flexed, thereby changing the pitch of the sound produced by the sound generating arrangement.

According to still another exemplary embodiment of the present invention, the coupling arrangement can include an opening configured to receive the first arrangement. The second arrangement can further include a groove configured to receive the coupling arrangement. The second arrangement can also include a lanyard holder.

These and other objects, features and advantages of the present invention will become apparent upon reading the following detailed description of embodiments of the invention, when taken in conjunction with the appended claims.

### BRIEF DESCRIPTION OF THE DRAWINGS

Further objects, features and advantages of the invention will become apparent from the following detailed description taken in conjunction with the accompanying figures showing illustrative embodiments of the invention, in which:

FIG. 1 is a front perspective view of a sound generating arrangement in accordance with an exemplary embodiment of the present invention;

FIG. 2 is a rear perspective view of the sound generating arrangement of FIG. 1;

FIG. 3 is a top view of the sound generating arrangement of FIG. 1;

FIG. 4 is a front side view of the sound generating arrangement of FIG. 1;

FIG. 5 is a rear side view of the sound generating arrangement of FIG. 1;

FIG. 6 is a rotated side view of the sound generating arrangement of FIG. 1;

FIG. 7 is a side cross-sectional side view of the sound generating arrangement of FIG. 1;

FIG. 8 is a rotated side view of a body arrangement (e.g., a sound making arrangement) of the sound generating arrangement in accordance with an exemplary embodiment of the present invention;

FIG. 9 is a rear side view of the body arrangement of FIG. 8;

FIG. 10 is a front side view of the second arrangement of FIG. 8;

FIG. 11 is a side cross-sectional view of the second arrangement of FIG. 8;

FIG. 12 is a top view of a further arrangement (e.g., a mouthpiece) and a coupling arrangement of the sound generating arrangement in accordance with an exemplary embodiment of the present invention;

FIG. 13 is a side view of the further arrangement and the coupling arrangement of FIG. 12;

FIG. 14 is a side cross-sectional view of the further arrangement and the coupling arrangement of FIG. 12;

FIG. 15 is a front view of the further arrangement and the coupling arrangement of FIG. 12;

FIG. 16 is a top view of a protection arrangement of the sound generating arrangement in accordance with an exemplary embodiment of the present invention;

FIG. 17 is a side view of the protection arrangement of FIG. 16; and

FIG. 18 is a cross-sectional side view of the protection arrangement of FIG. 16.

Throughout the figures, the same reference numerals and characters, unless otherwise stated, are used to denote like features, elements, components or portions of the illustrated embodiments. Moreover, while the subject invention will now be described in detail with reference to the figures, it is done so in connection with the illustrative embodiments. It is intended that changes and modifications can be made to the described embodiments without departing from the true scope and spirit of the subject invention as defined by the appended claims.

### DETAILED DESCRIPTION OF EXEMPLARY EMBODIMENT(S) OF THE INVENTION

An exemplary embodiment of a sound generating arrangement comprises a first arrangement (e.g., a mouthpiece arrangement), a second arrangement (e.g., a sound making arrangement), and a coupling arrangement. The first arrangement may comprise an inlet tube, the second arrangement may comprise a horn, and the coupling arrangement may comprise an elastically deformable ring.

The exemplary embodiment of the sound generating arrangement may be used at sporting events, in play situations, during coaching, or in any situation where it is desirable to make noise. In addition, it is possible to make this exemplary assembly available to children at various food dispensing or amusement establishments.

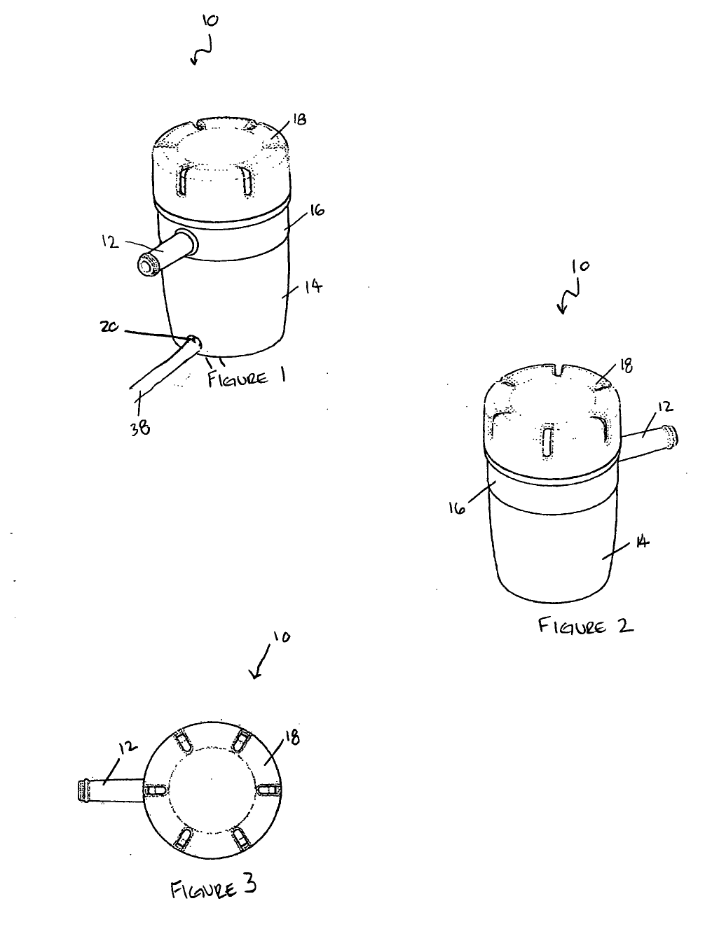

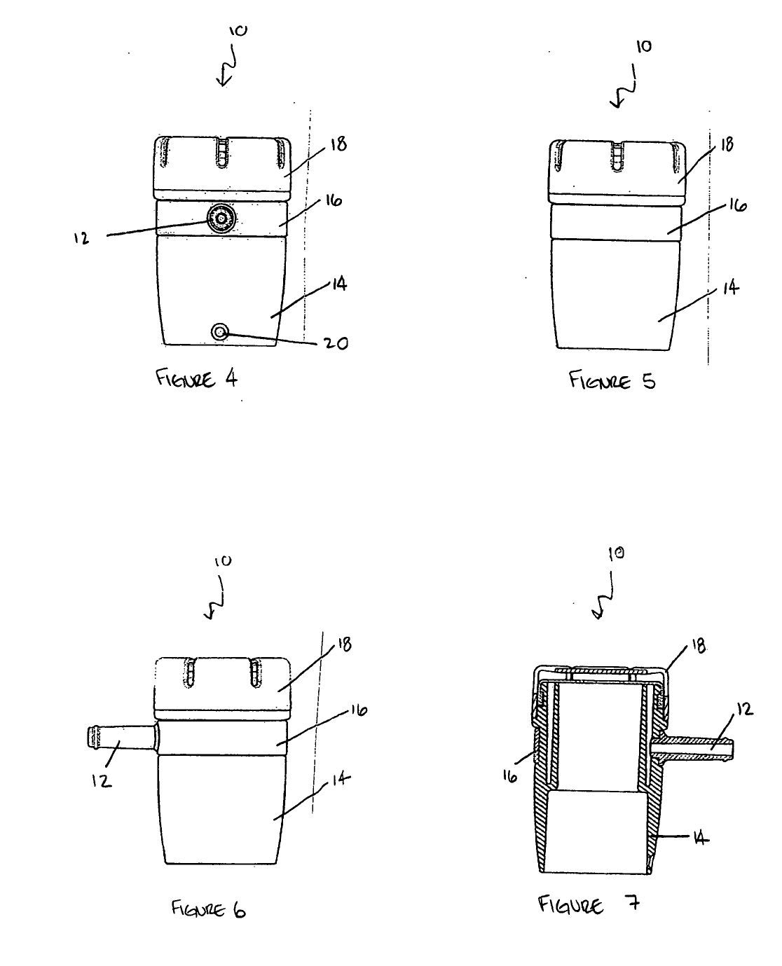

FIGS. 1-7 illustrate an exemplary embodiment of a sound generating arrangement 10 according to the present invention. FIGS. 1 and 2 illustrate front and rear perspective views of the sound generating arrangement 10, respectively. FIG. 3 illustrate a top view of the sound generating arrangement 10. FIGS. 4 and 5 illustrate front and rear side views of the sound generating arrangement 10, respectively. FIG. 6 illustrates a rotated side view of the sound generating arrangement 10 and 10 FIG. 7 illustrates a side cross-sectional view of the sound generating arrangement 10.

As shown in FIGS. 1-7, the exemplary embodiment of the sound generating arrangement 10 includes a first arrangement 12, a second arrangement 14 and a coupling arrangement 16. In the exemplary embodiment shown therein, the first arrangement 12 comprises a mouthpiece arrangement, the second arrangement 14 comprises a sound making arrangement, and the coupling arrangement 16 comprises an elastically deformable ring. The coupling arrangement 16 is configured to couple the first arrangement 12 to the second arrangement 14. Such connection may be temporary or permanent. A membrane cover or a protective part 18 can be further provided for the sound generating arrangement. A lanyard holder 20 for receiving a lanyard may be provided at any suitable location on the sound generating arrangement 10. In the exemplary embodiment shown in FIGS. 1-7, the lanyard holder 20 is provided on the second arrangement 14.

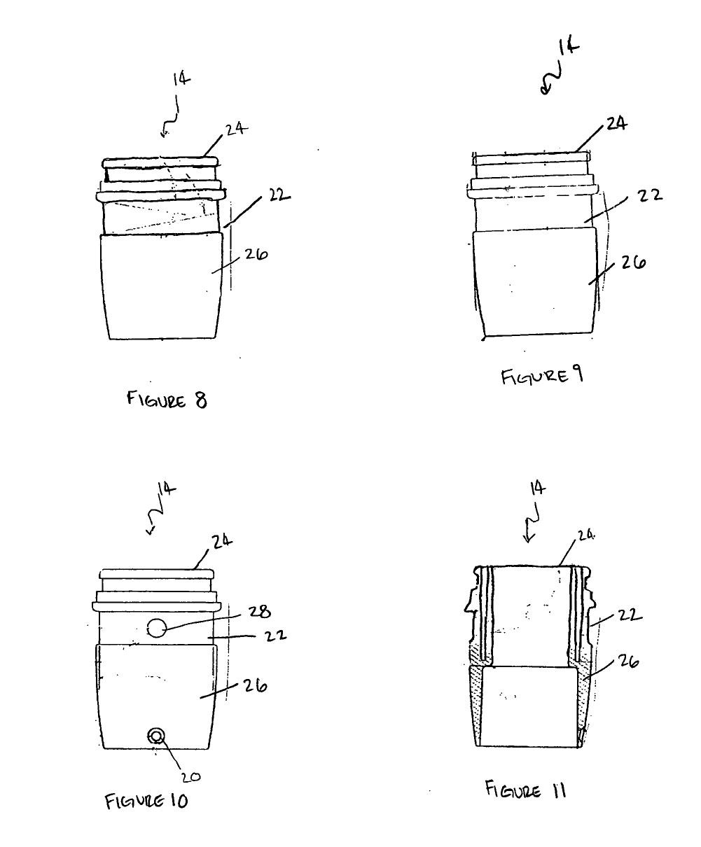

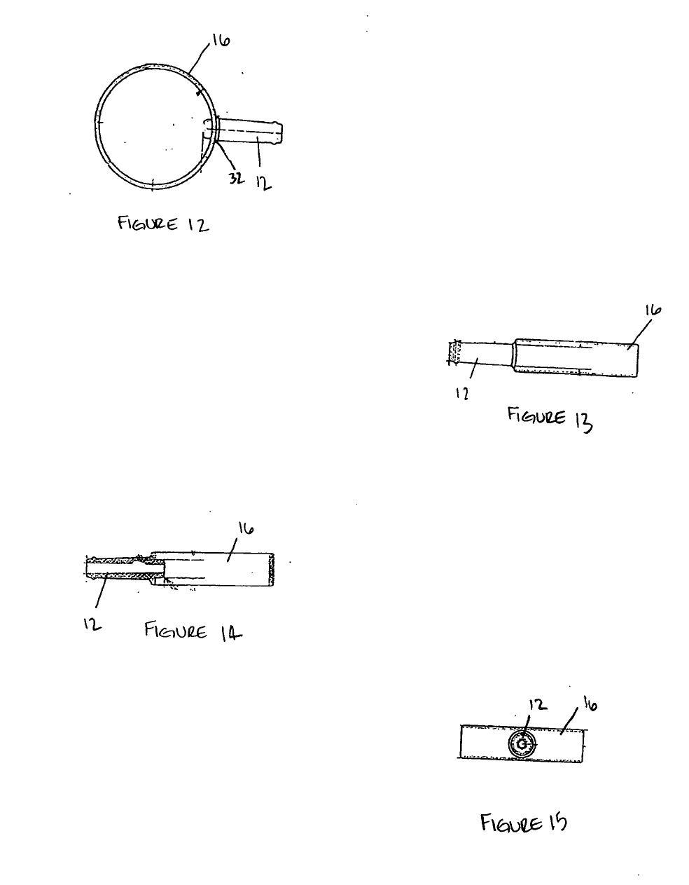

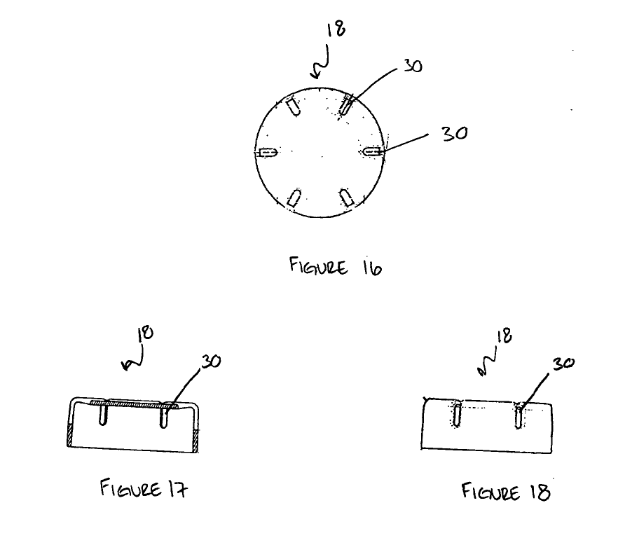

In one exemplary embodiment, the first arrangement 12 can be press fit to the coupling arrangement 16, as described further below with reference to FIGS. 12 through 15. In alternative exemplary embodiments, the connection of the first arrangement 12 to the coupling arrangement 16 may be made via any suitable mechanism or way. For example, the connection can be made using a threaded screw fit, an adhesive, or in any other manner. The coupling arrangement 16 can then be fit in a corresponding slot, groove, or recess 22 of the second arrangement 14 (see FIGS. 8-11). Thus, the coupling arrangement 16 (or a ring) may be slid over the second arrangement 14 and into the slot, groove, or recess 22 to couple the first arrangement 12 to the second arrangement 14. Advantages of such exemplary design can include a faster production and possibly a reduced chance of produce failure due to the first arrangement 12 being separated from the second arrangement 14. An adhesive may additionally be used to fix the coupling arrangement 16 to the second arrangement 14.

As shown in further detail in FIGS. 8-11, the exemplary first arrangement 12 can include a sound generating assembly. In the exemplary embodiment shown in these figures, the sound generating assembly can include an elastic membrane/rubber portion or diaphragm 24, a base structure 26, and an inlet opening 28. The first arrangement 12 can include the slot, groove, or recess 22 for receiving the coupling arrangement 16. The inlet opening 28 is provided on the slot, groove or recess 22 such that the first arrangement 12 (or the mouthpiece) may be generally aligned with the inlet opening 28. A membrane cover or a protection part 18 (shown in FIGS. 16-18) may further be provided with the first arrangement 12 and/or can be used as a membrane as well.

The diaphragm 24 may be manufactured of any suitable material. For example, the diaphragm 24 may be made of rubber, silicone, latex, vinyl, mylar, and/or other material. In operation, vibrations of the diaphragm 24 can be induced by an air flow generated between the membrane 24 and an adjacent housing in the base structure 26. The diaphragm 24, in combination with the housing, may form a substantially sealed chamber. The sealed chamber can provide rebounding compression against the diaphragm 24 as the diaphragm 24 is forced or expended into the chamber by the air flow. By placing user mouth on the first arrangement 12 and blowing there through, air flows past the diaphragm 24 (while inspecting the membrane 24) and out of the second arrangement 14. The sound generating arrangement 10 is thus configured to provide a sound or noise. Another way of generating sound/noise using the sound generating arrangement 10 may be effectuated. For example, a compressed air source (as known to those skilled in the art) may be coupled to the first arrangement for generating air flow to, at or past the diaphragm 24.

The first arrangement 12 comprises an inlet tube for blowing air across the diaphragm 24 of the second arrangement 14. Any suitable material may be used for manufacturing the inlet tube 22. For example, a rigid plastic such as high impact styrene may be used. Alternately, a soft material with, for example, a rubber-like feel may be utilized. In certain exemplary embodiments, a soft material may be advantageously used so as to reduce the likelihood of injury to the user's face or teeth. As described above, the first arrangement 12 is coupled to the coupling arrangement 16 so as to connect the first arrangement 12 to the second arrangement 14. The coupling arrangement may be manufactured of any suitable material. In an exemplary embodiment, the coupling arrangement 16 can be elastically deformable, and may include an opening 32 for receiving the first arrangement 12. The elastically deformable characteristics of the coupling arrangement 16 can cause it to stretch so as to receive the first arrangement 12, and to contract around the first arrangement 12 once it is received. The coupling arrangement 16 may then be elastically deformed to slide the coupling arrangement 16 over the second arrangement 14 and into the groove or recess 22 of the second arrangement 14. In alternative exemplary embodiments, the coupling arrangement 16 may be substantially rigid or flexible, and substantially not deformable. For example, in one exemplary embodiment, the coupling arrangement 16 may comprise a plastic ring with an opening in a portion thereof for extending around the second arrangement 14. Alternately, any suitable manner of coupling the first arrangement 12 to the coupling arrangement 16 and the coupling arrangement 16 to the second arrangement 14 may be implemented. Alternate ways for generating air flow across the diaphragm 24 may be used instead of or in addition to the use of the inlet tube of the first arrangement 12.

A diaphragm cover, a membrane cover or a protective part 18 may be provided for the sound generating arrangement 10 to protect the diaphragm 24, and is shown in detail in FIGS. 16-18. The diaphragm cover 18 may be provided for a possible user's replacement of the diaphragm 24. Air vents 30 are provided on and in the diaphragm cover 18 such that air may pass externally of the first arrangement 12 to the diaphragm 24. The air vents 30 may be customized, for example, as a mascot or a logo.

According to another exemplary embodiment of the present invention, the diaphragm cover or protective part 18 may be provided with a small dimple on the underside thereof. The diaphragm cover 18 may be manufactured of a flexible material such as a plastic or polymer. Thus, a user can press down on the cover, thereby stretching the membrane and changing the pitch of the horn. This additional exemplary feature can make the sound generating arrangement more interactive and fun to use.

A lanyard holder 20 may also be provided, as shown in FIGS. 1, 4, and 10. As shown, the lanyard holder 20 may be integral with the second arrangement 14. Alternately, the lanyard holder 20 may be provided in an alternate location on the sound generating assembly 10. A lanyard 38 may be inserted through the lanyard holder 36, and the sound generating arrangement 10 may be worn around the user's neck.

In the exemplary embodiment shown in the figures, the sound generating arrangement 10 can be sounded by blowing through the inlet tube of the first arrangement 12 to provide a stream of air past the diaphragm 24 and through the second arrangement 14. Again, alternate ways of providing air flow past the diaphragm 24 may be provided.

The exemplary embodiments of the present invention thus provide an easily assembled, lightweight and relatively inexpensive sound generating arrangement.

It should be understood that there can be various shapes and configurations of the sound generating arrangement are conceivable and are within the scope of the present invention. For example, the shape and configuration of the second arrangement can be modified in accordance with the requests of customers.

While the invention has been described in connecting with preferred embodiments, it will be understood by those of ordinary skill in the art that other variations and modifications of the preferred embodiments described above may be made without departing from the scope of the invention. Other embodiments will be apparent to those of ordinary skill in the art from a consideration of the specification or practice of the invention disclosed herein. It is intended that the specification and the described examples are considered as exemplary only, with the true scope and spirit of the invention indicated by the following claims.

What is claimed is:

1. A sound generating arrangement comprising:
a first arrangement configured to provide a flow of a gas there through;
a second arrangement configured to facilitate a generation of at least one sound when being contacted by the gas; and
a coupling arrangement having elastically deformable characteristics,
wherein the first arrangement is configured to couple to the coupling arrangement, and the coupling arrangement is configured to couple to the second arrangement.

2. The sound generating arrangement of claim 1, wherein the second arrangement comprises an elastic membrane and the first arrangement comprises an inlet tube, and wherein the inlet tube extends toward the membrane.

3. The sound generating arrangement of claim 2, wherein the second arrangement further comprises a base assembly supporting the membrane.

4. The sound generating arrangement of claim 2, further comprising a membrane cover to be placed over the membrane.

5. The sound generating arrangement of claim 4, wherein the membrane cover includes at least one opening for the gas flow to be provided therethrough.

6. The sound generating arrangement of claim 5, wherein the at least one opening includes a plurality of openings provided in a customizable configuration.

7. The sound generating arrangement of claim 4, wherein the membrane cover further comprises a dimple on an underside thereof, and wherein, by pressing on the membrane cover, the membrane dimple contacts the membrane and is flexed, thereby changing the pitch of the sound produced by the sound generating arrangement.

8. The sound generating arrangement of claim 1, wherein the coupling arrangement includes an opening configured to receive the first arrangement.

9. The sound generating arrangement of claim 1, wherein the second arrangement further comprises a groove configured to receive the coupling arrangement.

10. The sound generating arrangement of claim 1, wherein the second arrangement comprises a lanyard holder.

11. The sound generating arrangement of claim 1, wherein the first arrangement includes a moth piece.

12. The sound generating arrangement of claim 1, wherein the second arrangement includes a sound generating assembly.
